(19) United States
(12) Patent Application Publication
(10) Pub. No.: US 2026/0119217 A1
(43) Pub. Date: Apr. 30, 2026

(54) METHOD FOR PROVIDING A USER INTERFACE PATTERN RECOMMENDATION SERVICE AND A COMPUTER-READABLE RECORDING MEDIA THEREOF

(71) Applicant: Hyun Kyung MIN, Suwon-si (KR)

(72) Inventor: Hyun Kyung MIN, Suwon-si (KR)

(21) Appl. No.: 19/255,581

(22) Filed: Jun. 30, 2025

(30) Foreign Application Priority Data
Oct. 29, 2024 (KR) 10-2024-0149639

(51) Int. Cl. G06F 9/451; G06F 16/9535; G06F 18/22; G06F 40/35; H04L 51/02

(52) U.S. Cl. CPC G06F 9/453; G06F 16/9535; G06F 18/22; G06F 40/35; H04L 51/02

(57) ABSTRACT

Provided is a method for providing a user interface pattern recommendation service. In the method: (a) an administrator terminal registers app information; (b) a user terminal selects the app information and inputs a question to request a chatbot query; (c) a platform server refers to a platform DB and transmits key data including an UI pattern, a user preference, and a selection history via an information inquiry API; (d) an AI model within the platform server receives user input data, analyzes the data in real time using RAG technology and a self-trained model, and recommends a UI pattern preferred by a user; (e) a chatbot response module within a chatbot server receives the chatbot query; (f) the chatbot response module generates a chatbot response by referring to a chatbot DB; and (g) the chatbot response API receives the generated chatbot response and transmits the response to the user terminal.

### CROSS-REFERENCE TO RELATED APPLICATION

This application claims the benefit of and priority to Korean Patent Application No. 10-2024-0149639, filed on Oct. 29, 2024, the entire disclosure(s) of which is hereby incorporated herein by reference in its entirety.

### TECHNICAL FIELD

The present disclosure relates to a method for providing a pattern recommendation service and, more particularly, to a method for providing a user interface pattern recommendation service and a computer-readable recording medium thereof.

### BACKGROUND

Generally, generative AI refers to artificial intelligence that learns from given data and generates similar data based on the learning data, and is mainly classified into models that generate text, images, sound, and video.

Among text-based generative AI models, ChatGPT is the most famous. However, since the ChatGPT fundamentally generates answers based on previously input data, it provides detailed explanations even in response to nonsensical questions while sometimes fabricating facts that do not exist.

As an alternative, Retrieval Augmented Generation (RAG) technology has been introduced, which retrieves information from an external knowledge base and applies it to a large language model (LLM) to generate a response.

Meanwhile, AI hallucination refers to a phenomenon in which an AI model generates incorrect or fabricated information that is unrelated to actual data or facts.

This is mainly observed in the large language model, and occurs due to factors such as inaccuracies in training data, bias in data, or inconsistencies between datasets.

For example, incorrect training on specific words or contexts may lead to hallucination, causing AI to generate fictional facts. This phenomenon is especially common in text-based generative AI, and may result in inaccurate answers to user questions.

In today's world where AI is widely used, hallucination can not only spread misinformation and confuse users, but also lead to serious consequences (e.g. in the medical and legal fields) if used in making critical decisions.

Therefore, there is a critical and urgent need to develop a method for detecting and minimizing hallucination in order to improve the accuracy of AI models and ensure the safe application of AI in real-world situations.

### PRIOR ART DOCUMENT

(Patent Document) U.S. Pat. No. 11,532,025 B2

### SUMMARY

The present disclosure provides a method for providing a user interface pattern recommendation service that can automatically find and recommend a user-friendly, fast, and accurate UI/UX pattern, by making AI decision based on user requirements through a RAG technique and the automation of a filtering function.

In an aspect, a method for providing a user interface pattern recommendation service includes (a) a step in which an administrator terminal registers at least one app information and adjusts a training model and deployment settings, in a front-end stage; (b) a step in which a user terminal selects the at least one app information and inputs a question related to the app to request a chatbot query, in the front-end stage; (c) a step in which a platform server, in conjunction with an app registration API, refers to a platform DB and transmits key data including an UI pattern, a user preference, and a selection history via an information inquiry API, in a back-end stage; (d) a step in which an AI model within the platform server receives user input data from the user terminal, analyzes the data in real time using retrieval-augmented generation (RAG) technology and a self-trained model thereof, and recommends a UI pattern preferred by a user; (e) a step in which a chatbot response module within a chatbot server receives the chatbot query requested from the user terminal via the chatbot response API within the platform server, in the back-end stage; (f) a step in which the chatbot response module generates a chatbot response by referring to a chatbot DB; and (g) a step in which the chatbot response API receives the generated chatbot response and transmits the response to the user terminal.

The at least one app information may include a Monthly Active User (MAU), the UI pattern, a UI component, a category, and a color.

The step (d) may include (d-1) a step in which a decision engine within the platform server analyzes a user's history and analyzes similarity between user input data and the UI pattern in real time to make a real-time decision for personalized recommendation; and (d-2) a step in which a recommendation engine within the platform server recommends a user-tailored UI pattern in real time based on filtered data stored in the platform DB.

The method may further include, after the step (d-2), (d-3) a step in which a chatbot training module within the chatbot server receives feedback from the user terminal regarding the recommended result and learns based on the feedback.

In the step (b), when the user terminal selects the at least one app information, a main conversation window screen of a chatbot may be displayed on the user terminal.

The main conversation window screen of the chatbot may include a 1-1 area showing a UI/UX pattern as text based on an own data; a 1-2 area showing top two images of the UI/UX pattern; a 1-3 area showing a preference matching probability based on a user's usual behavior pattern; a 1-4 area showing the recommendation of a pattern similar to a user's data-based preference; and a 1-5 area displaying a predicted generation date of the UI/UX pattern.

In the step (d), when the preferred UI pattern is recommended, a detailed screen is displayed.

The detailed screen may include a 2-1 area showing a recommended popular UI/UX pattern and user preference probability based on an own data; a 2-2 area showing a predicted generation date of the UI/UX pattern; a 2-3 area showing preference matching probability based on the user's usual behavior pattern; and a 2-4 area showing pattern recommendation corresponding to preference based on user data.

In the step (d), after the preferred UI pattern is recommended, a first-step screen of “Add Service” may be displayed.

The first-step screen of the “Add Service” may include a 3-1 area in which an app name is registered; a 3-2 area in which the MAU corresponding to the app is entered; a 3-3 area in which an update date is entered in a year-month format; a 3-4 area in which a category selection corresponding to the app is entered; a 3-5 area in which a color selection corresponding to match the app is entered; and a 3-6 area in which a “Next” button is displayed that, when clicked, proceeds to a second step.

When the “Next” button is clicked, a second-step screen of the “Add Service” may be displayed.

The second-step screen of the “Add Service” may include a 4-1 area in which selected UI pattern is displayed; a 4-2 area in which detail settings of the selected UI pattern; and a 4-3 area in which flow settings of the selected UI pattern.

In an aspect, information on a user interface pattern recommendation service providing method may be stored in a computer-readable recording medium.

### Advantageous Effects

According to the present disclosure, a user's behavior pattern and preference are accurately and rapidly analyzed based on interaction with the user, thereby making personalized UI/UX pattern recommendations remarkably sophisticated.

Further, rather than simply recommending the UI/UX pattern, it can minimize AI hallucination and provide explanations on how well the recommended pattern fits a specific situation, thereby facilitating users to make better decisions.

In addition, since a chatbot instantly suggests a pattern that matches the user's needs, working time can be drastically reduced.

Furthermore, by utilizing AI to analyze various data and patterns and provide the most suitable design solution, it is possible to recommend a pattern that fits the purpose of a project, thereby significantly improving design completeness.

In addition, as it provides a wide range of popular UI/UX patterns not only not domestically but also internationally, it is possible to recommend patterns from various countries and styles to meet diverse user needs.

### BRIEF DESCRIPTION OF THE DRAWINGS

FIG. 1 is a block diagram showing a system for implementing a method for providing a pattern recommendation service according to a first embodiment of the present disclosure.

FIG. 2 is a flowchart showing a method for providing a user interface pattern recommendation service according to a first embodiment of the present disclosure.

FIG. 3 is a main conversation window screen of a chatbot displayed on a user terminal when the user terminal selects at least one app information, in step S200 shown in FIG. 2.

FIG. 4 is a detailed screen that is displayed when a preferred UI pattern is recommended, in step S400 shown in FIG. 2.

FIG. 5 is a first-step screen of “Add Service” that is displayed after a preferred UI pattern is recommended, in step S400 shown in FIG. 2.

FIG. 6 is a second-step screen of “Add Service” that is displayed after the first step of “Add Service”, in step S400 shown in FIG. 2.

FIG. 7 is a screen showing the adjustment of the number of clickable users in a “MAU Registration” process shown in FIG. 5.

FIG. 8 is a screen showing the list of selectable UI patterns in a “UI Pattern Selection” process shown in FIG. 6.

FIG. 9 is a screen showing the list of selectable categories in a “Category Registration” process shown in FIG. 5.

FIG. 10 is a screen showing the list of selectable colors in a “Color Registration” process shown in FIG. 5.

FIG. 11 is a screen for a list of UI components among at least one app information registered, in step S130 shown in FIG. 2.

### DETAILED DESCRIPTION

The above and other objectives, features, and advantages of the present disclosure will be easily understood from the following embodiments in conjunction with the accompanying drawings. However, the present disclosure may be embodied in different forms without being limited to the embodiments set forth hereinbelow. Rather, the embodiments disclosed herein are provided to make the disclosure thorough and complete and to sufficiently convey the spirit of the present disclosure to those skilled in the art, and the present disclosure is defined solely by the claims.

The terminology used herein is for the purpose of describing embodiments only and is not intended to be limiting. In the present disclosure, the singular forms are intended to include the plural forms as well, unless the context clearly indicates otherwise. The terms “comprises” and/or “comprising” when used herein do not preclude the presence or addition of one or more other components. The same reference numerals are used throughout the drawings to designate the same components, and the terms “and/or” specify the presence of stated components and a combination thereof. It will be understood that, although the terms “first”, “second”, etc. may be used herein to describe various components, these components should not be limited by these terms. These terms are only used to distinguish one component from another component. Thus, a first component could be termed a second component without departing from the teachings of the present disclosure.

Unless otherwise defined, all terms including technical and scientific terms used herein have the same meaning as commonly understood by one of ordinary skill in the art to which the present disclosure belongs. Further, terms used herein will not be interpreted in an idealized or overly formal sense unless expressly so defined herein.

It will be understood that, although the terms “first”, “second”, “A”, “B”, etc. may be used herein to describe various components, these components should not be limited by these terms. These terms are only used to distinguish one component from another component. For instance, a first component discussed below could be termed a second component without departing from the teachings of the present disclosure. Similarly, the second component could also be termed the first component. The term “and/or” includes any combination of multiple related described items or any one of multiple related described items.

The term “unit” or “module” used throughout the present disclosure may mean a unit that processes at least one function or operation. The term “unit” or “module” may mean a hardware component, such as a software, FPGA, or ASIC. However, the “unit” or “module” is not limited to software or hardware. The “unit” or “module” may be configured to be present in an addressable storage medium and executed by one or more processors. Thus, as an example, the “unit” or “module” includes components such as software components, object-oriented software components, class components and task components, as well as processes, functions, attributes, procedures, subroutines, segments of program code, drivers, firmware, microcode, circuitry, data, databases, data structures, tables, arrays and variables. The functions provided within “units” or “modules” may be combined with one or more other components, or may be further divided into “units” or “modules”.

Hereinafter, an embodiment of the present disclosure will be described in detail with reference to the accompanying drawings.

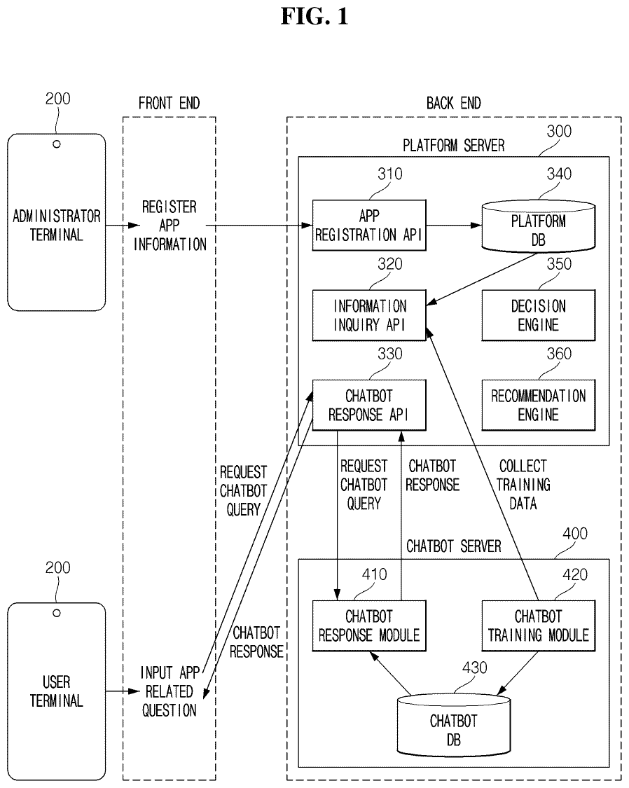

FIG. 1 is a block diagram showing a system for implementing a method for providing a user interface pattern recommendation service according to a first embodiment of the present disclosure, and includes an administrator terminal 100, a user terminal 200, a platform server 300, and a chatbot server 400.

The platform server 300 includes an app registration API 310, an information inquiry API 320, a chatbot response API 330, a platform DB 340, a decision engine 350, and a recommendation engine 360. The chatbot server 400 includes a chatbot response module 410, a chatbot training module 420, and a chatbot DB 430.

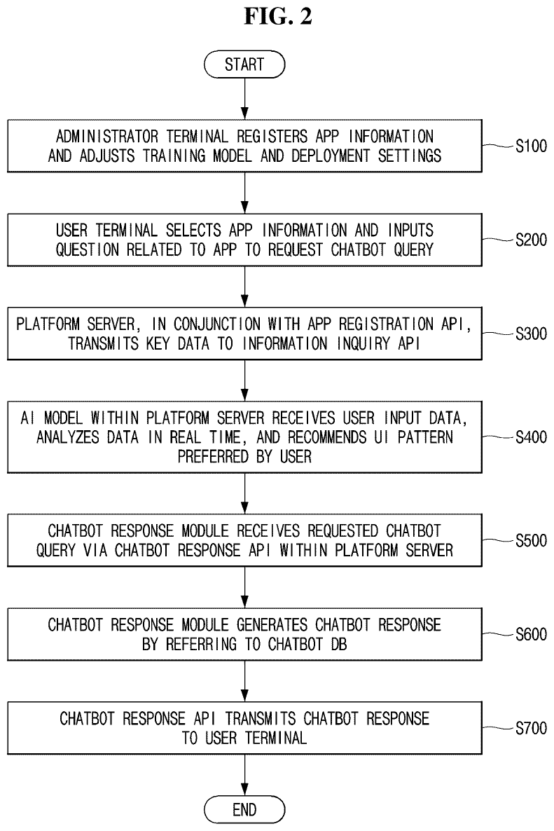

FIG. 2 is a flowchart showing a method for providing a user interface pattern recommendation service according to a first embodiment of the present disclosure.

The schematic operation of the user interface pattern recommendation service providing method according to the first embodiment of the present disclosure will be described below with reference to FIGS. 1 and 2.

In a front-end stage, the administrator terminal 100 registers at least one app information and adjusts a training model and distribution settings (S100).

In the front-end stage, the user terminal 200 selects at least one app information and inputs a question related to the app to request a chatbot query (S200).

In a back-end stage, the platform server 300, in conjunction with the app registration API 310, refers to the platform DB 340 and transmits key data including an UI pattern, a user preference, and selection history via the information inquiry API 320 (S300).

An AI model within the platform server 300 receives user input data from the user terminal 200, analyzes the data in real time using retrieval-augmented generation (RAG) technology and its self-trained model, and recommends a UI pattern preferred by the user (S400).

In the back-end stage, the chatbot response module 410 within the chatbot server 400 receives the chatbot query requested from the user terminal 200 via the chatbot response API 330 of the platform server 300 (S500).

The chatbot response module 410 generates a chatbot response by referring to the chatbot DB 430 (S600).

The chatbot response API 330 receives the chatbot response generated in step S600 and transmits it to the user terminal 200 (S700).

The detailed operation of the user interface pattern recommendation service providing method according to the first embodiment of the present disclosure will be described below with reference to FIGS. 1 and 2.

In the front-end stage, the administrator terminal 100 registers app information by selecting Monthly Active User (MAU), UI patterns, UI components, categories, and colors, and adjusts the training model and deployment settings through training and deployment settings.

In the front-end stage, the user terminal 200 selects the monthly active user, UI pattern, UI component, category, and color, and inputs a question related to the app to request a chatbot query. This input is stored in a personalization DB and may be used for future personalized recommendation.

In the back-end stage, the platform server 300, in conjunction with the app registration API 310, refers to the platform DB 340 and transmits various important data, such as UI patterns, user preferences, and selection history, to the information inquiry API 320.

At this time, through a text embedding process, the UI pattern and user input data are converted to a vector format that is a shared representation space interpretable by a machine. This vector format is later used in a filtering process and filtered embedding data is stored in a filter DB within the platform DB 340.

The filtering process learns each user's specific preferences or interests (e.g., exercise style, health management goals, frequently purchased shopping items) to recommend content tailored to the preferences or interests.

This is suitable for suggesting the most relevant UI/UX patterns or services based on the user's input information and behavioral history.

For example, in a fitness app, similar exercise plans may be recommended based on a user's exercise history, while in shopping, new products may be recommended based on previous purchase records.

The AI model within the platform server 300, which serves as an artificial intelligence server, receives the user input data and analyzes it in real time using its self-trained model to recommend UI patterns preferred by the user.

In addition, the AI model compares the user input data with patterns in an embedded vector space to generate an optimal recommendation result.

That is, the decision engine 350 within the platform server 300 analyzes the user's history and analyzes similarity between the user input data and the UI patterns in real time to make real-time decisions for personalized recommendations.

The decision engine 350 operates dynamically based on the user input data to deliver the recommendation result and provides the optimized recommendation result in real time.

At this time, the optimized recommendation result is generated by calculating vector similarity based on both the user's past input data and real-time input. Further, recommendations may be made based on data from other users who exhibit similar patterns.

For example, patterns or exercise routines frequently used by users with similar sleep habits may be recommended.

Thereby, the present disclosure can provide personalized recommendations and automatically recommend relevant content even without explicit user requests.

In addition, the recommendation engine 360 within the platform server 300 recommends an appropriate UI pattern in real time based on the filtered data stored in the filter DB within the platform DB 340.

The platform server 300 receives user feedback on the recommended result and continuously learns to improve future recommendation performance.

At this time, the feedback on the recommended result is stored in a personal history DB within the chatbot DB 430, which stores user-specific data based on user preferences, past interactions, and selection history.

The platform server 300 accesses data stored in the personal history DB to provide more refined personalized recommendations.

That is, the user terminal 200 determines the types of recommendations available by checking the presence of data in the personal history DB, generates inference input data for the decision model, and transmits it to the platform server 300 for access.

The chatbot response API 330 receives a chatbot query from the user terminal 200, delivers it to the chatbot response module 410 within the chatbot server 400, receives the chatbot response generated with reference to the chatbot DB 430 from the chatbot response module 410 within the chatbot server 400, and transmits the response to the user terminal 200 in the front-end stage.

In addition, the chatbot training module 420 within the chatbot server 400 accesses the data stored in the chatbot DB 430, learns from the chatbot response, and transmits the learned information to the information inquiry API 320 within the platform server 300.

That is, by analyzing the conversation history between the chatbot server 400 and the user terminal 200, user behavior patterns may be identified, deriving insights required for service improvement. For example, frequently asked questions (FAQs) may be identified to optimize responses, or a recommendation algorithm may be adjusted based on changes in user interests.

In addition, the chatbot training module 420 may provide a dashboard through which an administrator or operator may monitor the chatbot's performance and review conversation logs. This enables real-time evaluation of the chatbot's response accuracy and supports immediate correction and improvement when necessary.

Meanwhile, the present disclosure can provide the most suitable design solution by analyzing various other data and patterns using AI. By analyzing the latest design trends and data, it recommends the most widely used or trend-appropriate patterns.

By integrating with AI, the data may be reflected in real time to present the most suitable pattern to the user, enabling the recommendation of high-quality data.

In addition, the present disclosure provides a wide range of UI/UX patterns that are popular not only domestically but also internationally, and can recommend patterns from various countries and styles tailored to the user's needs by combining this data with AI.

An example of the first embodiment constructs a chatbot system using the following method.

The key aspect of the present disclosure is to construct the chatbot system using AI that utilizes a large language model (LLM) and retrieval-augmented generation (RAG) technology.

Here, the large language model (LLM) is trained on massive amounts of data and uses billions of parameters to generate creative outputs for tasks such as question answering, language translation, and sentence completion.

The Retrieval-Augmented Generation (RAG) is a technique that retrieves information from an external database and generates natural responses based on that information. It optimizes the output of the large language model to reference a reliable knowledge base outside of a training data source before generating a response.

The RAG extends the capabilities of the already powerful LLM to a specific domain or an organization's internal knowledge base, eliminating a need to retrain the model. This is a cost-effective approach to enhancing LLM outcomes to maintain relevance, accuracy, and usefulness across various scenarios.

With this technology, when a user inputs a few selection values, the chatbot may retrieve relevant information from the database and provide it to the user.

For example, when a user wants to find products or information that meet specific conditions, the chatbot may automatically filter and provide the suitable information.

In the method of providing the UI/UX pattern service using the AI chatbot, the UI/UX patterns such as Monthly Active User (MAU), UI components, categories, flows, and colors are trained into the internal database.

Here, the Monthly Active User (MAU) refers to a metric that indicates the number of unique users who have used the service within a month. It usually refers to a metric indicating how many users actually use services such as the internet or games.

The training method is to preset the filter that may review UI pattern information on a dedicated administrator (or admin) page.

When a consumer interacts with the chatbot for the purpose of UI/UX pattern recommendation, a UI/UX pattern interface is provided.

When the consumer inputs requested information through the chatbot, at least one UI/UX pattern stored in the platform is recommended based on the requested information.

The recommendation method includes a personalized UI/UX pattern recommendation module that presents tailored UI/UX pattern content based on a user's website visit history, UI/UX pattern history, and UI/UX pattern view data.

In addition, the present disclosure applies natural language processing (NLP) technology to understand user queries and respond appropriately. This plays an important role in interpreting various expressions and contexts entered by the user and generating suitable responses accordingly.

To this end, a natural language processing engine is integrated, and the response accuracy of the chatbot is improved through continuous learning

Meanwhile, the present disclosure automates a filtering function that was conventionally performed manually by the user, allowing the user to quickly obtain a desired result by inputting only a few key selection values.

For example, when a user wants to find products within a specific price range in an online store or search for information within a particular category, the chatbot provides results based on the user's selection criteria

Further, personalized recommendations that are tailored based on the user's past behavior data or preferences may be provided.

For example, depending on the types of products the user frequently searches for or areas of interest, relevant information or products may be automatically recommended.

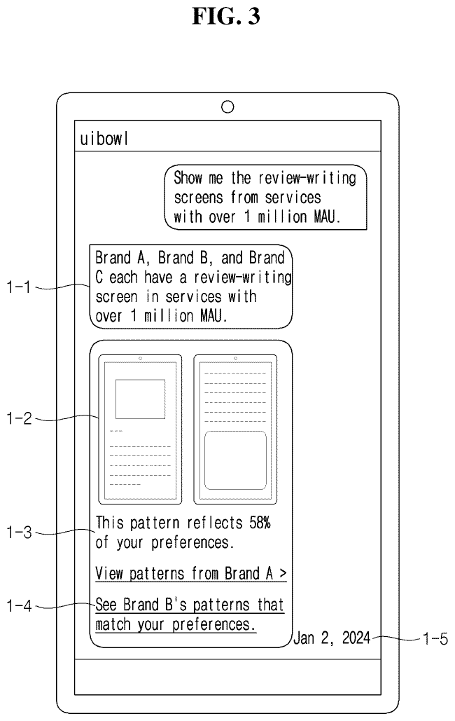

FIG. 3 is a main conversation window screen of the chatbot displayed on the user terminal when the user terminal selects at least one app information, in step S200 shown in FIG. 2.

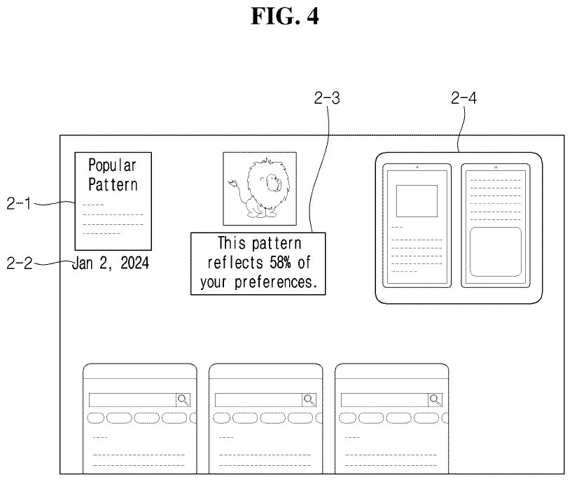

FIG. 4 is a detailed screen that is displayed when a preferred UI pattern is recommended, in step S400 shown in FIG. 2.

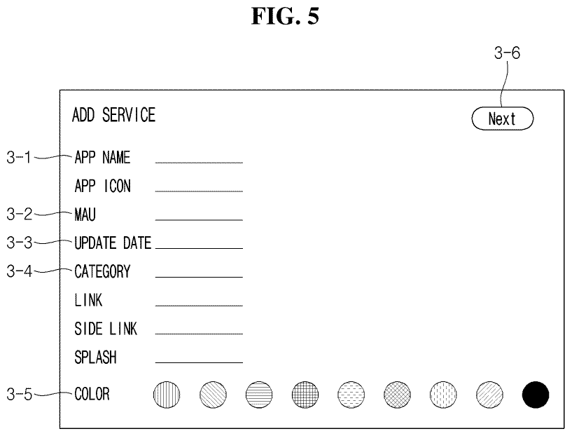

FIG. 5 is a first-step screen of “Add Service” that is displayed after a preferred UI pattern is recommended, in step S400 shown in FIG. 2.

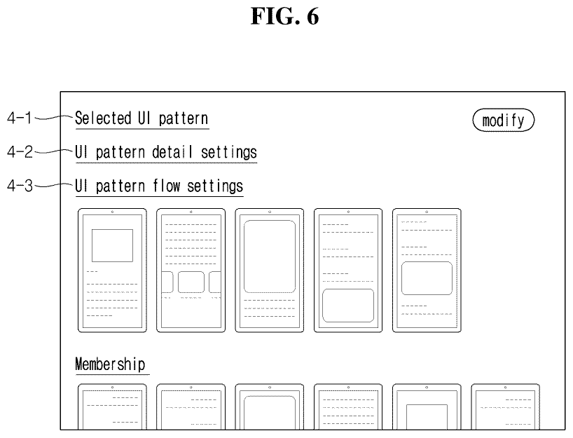

FIG. 6 is a second-step screen of “Add Service” that is displayed after the first step of “Add Service”, in step S400 shown in FIG. 2.

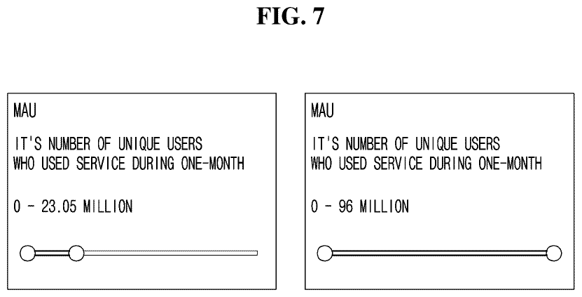

FIG. 7 is a screen showing the adjustment of the number of clickable users in a “MAU Registration” process shown in FIG. 5.

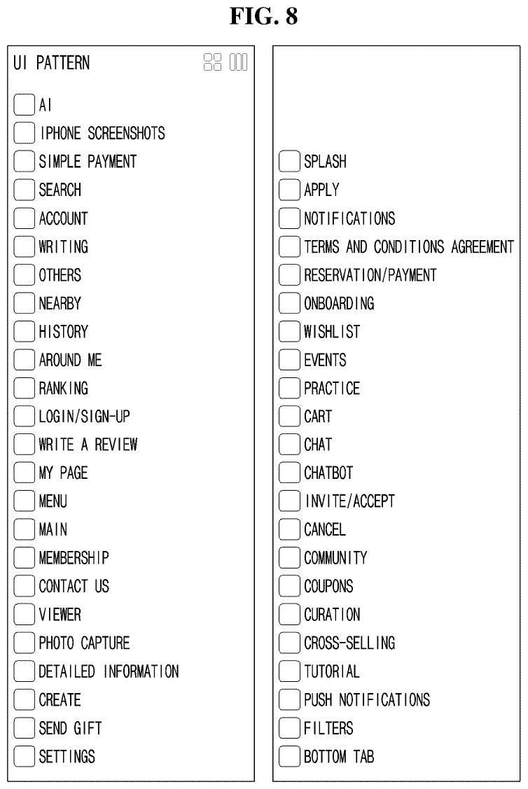

FIG. 8 is a screen showing the list of selectable UI patterns in a “UI Pattern Selection” process shown in FIG. 6.

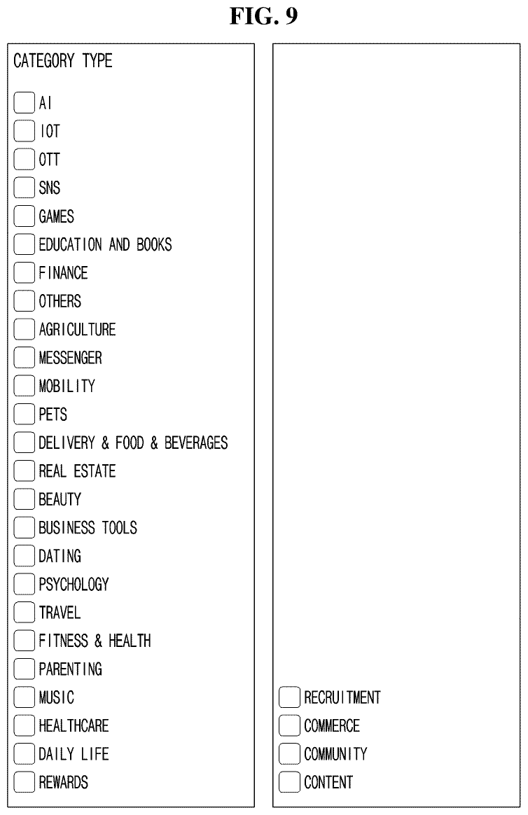

FIG. 9 is a screen showing the list of selectable categories in a “Category Registration” process shown in FIG. 5.

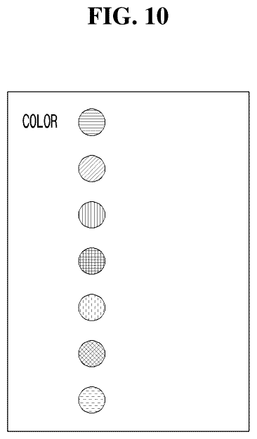

FIG. 10 is a screen showing the list of selectable colors in a “Color Registration” process shown in FIG. 5.

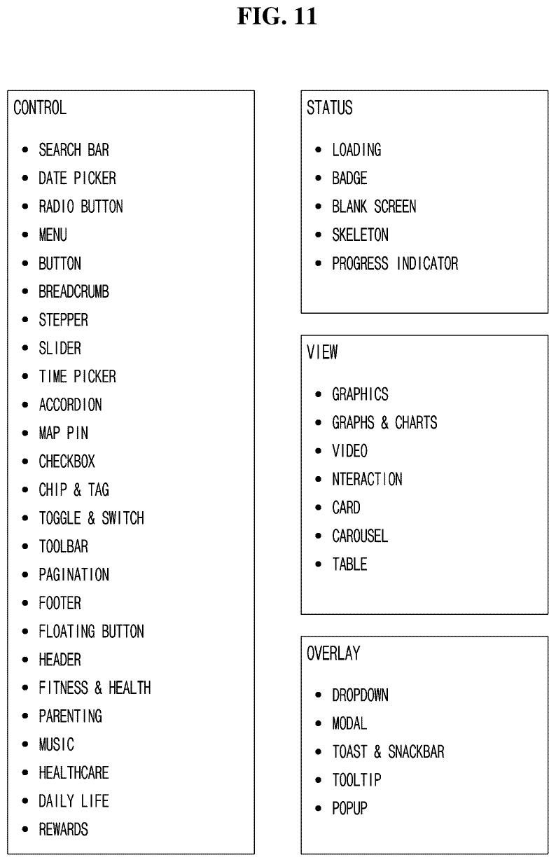

FIG. 11 is a screen for a list of UI components among at least one app information registered, in step S130 shown in FIG. 2.

The user interface pattern recommendation service providing method according to the first embodiment of the present disclosure will be described below in detail with reference to FIGS. 1 to 11.

As shown in FIG. 3, the main conversation window screen of the chatbot may be configured with the following UI/UX.

On the user terminal 200, the UI/UX patterns are displayed in 1-1 and 1-2 areas. The 1-1 area shows the UI/UX pattern as text based on its own data, while the 1-2 area shows the top two images of the UI/UX pattern.

Further, 1-3 and 1-4 areas show the preference percentage and UI/UX pattern preference curation, respectively, with the 1-3 area displaying the preference matching probability based on the user's usual behavior pattern, and the 1-4 area displaying the recommendation (personalization) of patterns similar to the user's data-based preference.

Furthermore, the predicted generation date of the UI/UX pattern is displayed in a 1-5 area, which clearly shows the predicted generation date of the UI/UX pattern.

As shown in FIG. 4, the detailed screen may be configured with the following UI/UX.

2-1 and 2-2 areas display the UI/UX pattern and the predicted generation date of the UI/UX pattern, respectively. The 2-1 area displays recommended popular UI/UX patterns and user preference probability based on its own data, while the 2-2 area displays the predicted generation date of the UI/UX pattern, which clearly shows the predicted generation date of the UI/UX pattern.

In addition, 2-3 and 2-4 areas display preference percentages and UI/UX pattern preference curation, respectively. The 2-3 area displays preference matching probability based on the user's usual behavior pattern, while the 2-4 area displays recommendations (personalization) of patterns similar to preference based on user data.

As shown in FIG. 5, the first-step screen of the “Add Service”, which is one of result information provision screens, may be configured with the following UI/UX.

The app name and MAU are registered in 3-1 and 3-2 areas, respectively. In the 3-1 area, the app name is registered, and in the 3-2 area, the MAU corresponding to the app is entered.

Further, the update date and category are registered in 3-3 and 3-4 areas, respectively. The 3-3 area contains the update date entered in a year-month format, and the 3-4 area shows a category selection corresponding to the app.

In addition, colors and a “Next” button are registered in 3-5 and 3-6 areas, respectively. The 3-5 area contains a color selection corresponding to match the app, and the 3-6 area shows a transition to the second step of the “Add service” upon clicking the “Next” button.

As shown in FIG. 6, the second-step screen of the “Add Service”, which is another result information provision screen, may be configured with the following UI/UX.

4-1 to 4-3 areas display a selected UI pattern, UI pattern detail settings, and UI pattern flow settings, respectively. In the 4-1 area, the selected UI pattern is displayed; in the 4-2 area, the detail settings of the selected UI pattern are displayed; and in the 4-3 area, the flow settings of the UI pattern are displayed.

As shown in FIG. 7, users may click a minimum of 0 and a maximum of 96 million MAUs using a slider.

FIG. 7(a) shows a case where the number of users ranges from 0 to 23.05 million, while FIG. 7(b) shows a case where it ranges from 0 to 96 million.

For example, if a curation page for services with over 1 million MAUs is displayed, the following content may subsequently be utilized.

Through user behavior analysis, it is possible to analyze which patterns or designs are most popular and which types of content users respond to more frequently via the curation page. Based on this analysis, popular patterns may be exposed more prominently, and personalized recommendations may be enhanced to match user preferences.

Through A/B testing, it is possible to evaluate how effective the recommended patterns on the curation page are—for example, whether users click more or stay longer. This allows data-driven improvements to be made to determine which curation strategy provides a better user experience.

Through design trend prediction, curated patterns may be used to identify current and future design trends. In particular, the continued popularity of specific patterns is likely to establish them as design trends, which can be suggested to other designers or utilized as educational content.

Through new marketing opportunities, marketing campaigns may be launched targeting specific customers based on the patterns frequently selected by users on the curation page. For example, related newsletters or advertisements may be sent to users who prefer UX patterns in a particular field.

Through the advancement of the recommendation system, more sophisticated recommendation algorithms may be developed based on data collected from the curation page. By analyzing user click patterns, dwell time, feedback, etc., the accuracy of recommendations can be improved, thereby increasing user satisfaction.

As shown in FIG. 8, the UI pattern is composed of a total of 46 patterns.

That is, the UI pattern is composed of patterns such as AI, iPhone screenshots, simple payment, search, account, writing, others, nearby, history, around me, ranking, login/sign-up, write a review, my page, menu, main, membership, contact us, viewer, photo capture, detailed information, create, send gift, settings, splash, apply, notifications, terms and conditions agreement, reservation/payment, onboarding, wishlist, events, practice, cart, chat, chatbot, invite/accept, cancel, community, coupons, curation, cross-selling, tutorial, push notifications, filters, and bottom tab.

As shown in FIG. 9, the category type is composed of a total of 29 patterns.

That is, the patterns include AI, IoT, OTT, SNS, games, education and books, finance, others, agriculture, messenger, mobility, pets, delivery & food & beverages, real estate, beauty, business tools, dating, psychology, travel, fitness & health, parenting, music, healthcare, daily life, rewards, recruitment, commerce, community, and content.

As shown in FIG. 10, a total of 8 color patterns are established.

That is, they are composed of patterns in white, black, green, yellow, pink, red, purple, and navy.

As shown in FIG. 11, a total of 38 UI component patterns are established.

In a control field, the patterns include search bar, date picker, radio button, menu, button, breadcrumb, stepper, slider, time picker, accordion, map pin, checkbox, chip & tag, toggle & switch, toolbar, pagination, footer, floating button, and header.

In a status field, the patterns include loading, badge, blank screen, skeleton, and progress indicator. In a view field, the patterns include graphics, graphs & charts, video, interaction, card, carousel, and table. In an overlay field, the patterns include dropdown, modal, toast & snackbar, tooltip, and popup.

As described above, the present disclosure provides a method for providing a user interface pattern recommendation service that can automatically find and recommend a user-friendly, fast, and accurate UI/UX pattern, by making AI decision based on user requirements through a RAG technique and the automation of a filtering function.

Thereby, the present disclosure accurately and promptly analyzes user behavior patterns and preferences based on interaction with a user, thereby making personalized UI/UX pattern recommendations significantly sophisticated.

Further, rather than simply recommending the UI/UX pattern, it can minimize AI hallucination and provide explanations on how well the recommended pattern fits a specific situation, thereby facilitating users to make better decisions.

In addition, since the chatbot instantly suggests a pattern that matches the user's needs, working time can be drastically reduced.

Furthermore, by utilizing AI to analyze various data and patterns and provide the most suitable design solution, it is possible to recommend a pattern that fits the purpose of a project, thereby significantly improving design completeness.

In addition, as it provides a wide range of popular UI/UX patterns not only not domestically but also internationally, it is possible to recommend patterns from various countries and styles to meet diverse user needs.

The method according to the present disclosure described above can be implemented as a program (or application) to be executed in combination with hardware such as a server and stored in a medium.

The above-described program may include code encoded in a computer language, such as C, C++, Java, or machine language, which may be read through a device interface of a computer by a controller (CPU) so that the computer reads the program and executes methods implemented in the program. Such code may include functional code related to functions defining the necessary functions to perform the above methods, and may include control code related to execution procedures required for the controller of the computer to execute the above functions according to a predetermined procedure. In addition, the code may further include storage reference-related code indicating a location (address number) in the computer's internal or external storage where additional information or media required for the execution of the functions by the controller of the computer should be referenced. Furthermore, if the controller of the computer needs to communicate with any other remote computer or server in order to execute the functions, the code may further include communication-related code specifying how to communicate with the remote computer or server using the computer's communication module, and what information or media should be transmitted and received during the communication.

The storage medium described above does not refer to a medium that stores data for a short period of time, such as a register, cache, or storage unit, but rather to a medium that stores data semi-permanently and is readable by a device. Specifically, examples of the storage medium include, but are not limited to, ROM, RAM, CD-ROM, magnetic tape, floppy disk, and optical data storage devices. That is, the program may be stored in various recording media on various servers accessible by the computer or in various recording media on a user's computer. Furthermore, the media may be distributed across computer systems connected via a network, and code readable by the computer may be stored in a distributed manner.

The steps of the method or algorithm described in connection with the embodiments of the present disclosure may be implemented directly in hardware, implemented as software modules executed by hardware, or implemented as a combination thereof. The software modules may reside in a Random Access Memory (RAM), Read Only Memory (ROM), Erasable Programmable ROM (EPROM), Electrically Erasable Programmable ROM (EEPROM), flash memory, hard disk, removable disk, CD-ROM, or any other form of computer-readable recording medium well known in the art to which the present disclosure pertains.

While the embodiments of the present disclosure have been described above with reference to the accompanying drawings, it will be understood by those skilled in the art that the present disclosure may be embodied in other specific forms without changing the technical spirit or essential characteristics thereof. Therefore, it is to be understood that the embodiments described above are illustrative in all respects and not restrictive.

What is claimed is:

1. A method for providing a pattern recommendation service, the method comprising:
(a) an operation in which an administrator terminal registers at least one app information and adjusts a training model and deployment settings, in a front-end stage;
(b) an operation in which a user terminal selects the at least one app information and inputs a question related to the app to request a chatbot query, in the front-end stage;
(c) an operation in which a platform server, in conjunction with an app registration API, refers to a platform DB and transmits key data including an UI pattern, a user preference, and a selection history via an information inquiry API, in a back-end stage;
(d) an operation in which an AI model within the platform server receives user input data from the user terminal, analyzes the data in real time using retrieval-augmented generation (RAG) technology and a self-trained model thereof, and recommends a UI pattern preferred by a user;
(e) an operation in which a chatbot response module within a chatbot server receives the chatbot query requested from the user terminal via the chatbot response API within the platform server, in the back-end stage;
(f) an operation in which the chatbot response module generates a chatbot response by referring to a chatbot DB; and
(g) an operation in which the chatbot response API receives the generated chatbot response and transmits the response to the user terminal,
wherein the operation (d) comprises:
(d-1) an operation in which a decision engine within the platform server analyzes a user's history and analyzes similarity between user input data and the UI pattern in real time to make a real-time decision for personalized recommendation; and
(d-2) an operation in which a recommendation engine within the platform server recommends a user-tailored UI pattern in real time based on filtered data stored in the platform DB.

2. The method of claim 1, wherein the at least one app information comprises a Monthly Active User (MAU), the UI pattern, a UI component, a category, and a color.

3. The method of claim 1, further comprising:
after the operation (d-2),
(d-3) an operation in which a chatbot training module within the chatbot server receives feedback from the user terminal regarding the recommended result and learns based on the feedback.

4. The method of claim 1, wherein, in the operation (b), when the user terminal selects the at least one app information, a main conversation window screen of a chatbot is displayed on the user terminal.

5. The method of claim 4, wherein the main conversation window screen of the chatbot comprises:
a 1-1 area showing a UI/UX pattern as text based on own data;
a 1-2 area showing top two images of the UI/UX pattern;
a 1-3 area showing a preference matching probability based on a user's usual behavior pattern;
a 1-4 area showing a recommendation of a pattern similar to a preference based on user data; and
a 1-5 area displaying a predicted generation date of the UI/UX pattern.

6. The method of claim 1, wherein, in the operation (d), when the preferred UI pattern is recommended, a detailed screen is displayed.

7. The method of claim 6, wherein the detailed screen comprises:
a 2-1 area showing a recommended popular UI/UX pattern and a user preference probability based on own data;
a 2-2 area showing a predicted generation date of the UI/UX pattern;
a 2-3 area showing a preference matching probability based on the user's usual behavior pattern; and
a 2-4 area showing pattern recommendation corresponding to preference based on user data.

8. The method of claim 1, wherein, in the operation (d), after the preferred UI pattern is recommended, a first-step screen of “Add Service” is displayed.

9. The method of claim 8, wherein the first-step screen of the “Add Service” comprises:
a 3-1 area in which an app name is registered;
a 3-2 area in which a MAU corresponding to the app is entered;
a 3-3 area in which an update date is entered in a year-month format;
a 3-4 area in which a category selection corresponding to the app is entered;
a 3-5 area in which a color selection corresponding to match the app is entered; and
a 3-6 area in which a “Next” button is displayed that, when clicked, proceeds to a second step.

10. The method of claim 9, wherein, when the “Next” button is clicked, a second-step screen of the “Add Service” is displayed.

11. The method of claim 10, wherein the second-step screen of the “Add Service” comprises:
a 4-1 area in which selected UI pattern is displayed;
a 4-2 area in which detail settings of the selected UI pattern are displayed; and
a 4-3 area in which flow settings of the selected UI pattern are displayed.

12. A computer-readable recording medium for a pattern recommendation service providing method, the recording medium having recorded thereon a program for executing on a computer all operations of the pattern recommendation service providing method according to claim 1.
